(19) United States
(12) Patent Application Publication
(10) Pub. No.: US 2025/0371428 A1
(43) Pub. Date: Dec. 4, 2025

(54) IMPROVING MODEL EMBEDDING ROBUSTNESS

(71) Applicant: THE TORONTO-DOMINION BANK, TORONTO (CA)

(72) Inventors: Atiyeh Ashari Ghomi, TORONTO (CA); Yi Sui, Newmarket (CA); Jesse Cole Cresswell, TORONTO (CA); George Frazer Stein, Port Coquitlam (CA); Jiapeng Wu, TORONTO (CA); Maksims Volkovs, TORONTO (CA)

(21) Appl. No.: 19/227,764

(22) Filed: Jun. 4, 2025

Related U.S. Application Data
(60) Provisional application No. 63/655,802, filed on Jun. 4, 2024.

(51) Int. Cl. G06N 20/00

(52) U.S. Cl. CPC G06N 20/00

(57) ABSTRACT

A computer model (e.g., an artificial intelligence model) having an encoder that generates embeddings may undesirably generate relatively large differences in embeddings for small changes in the input data sample. To improve robustness of the model against this type of change, training samples may be modified to generate adversarial examples that have comparatively large embedding differences relative to the change in training data sample. The adversarial data samples may be generated iteratively by exploring perturbations of the training data sample within a threshold to increase the distance in the embedding space. A robust encoder for the model may then be trained with the training data sample and adversarial data sample to reduce the distance between the corresponding training embedding and adversarial embedding.

### CROSS-REFERENCE TO RELATED APPLICATIONS

This application claims the benefit of U.S. Provisional Application No. 63/655,802, filed Jun. 4, 2024, the contents of which is hereby incorporated by reference in its entirety.

### BACKGROUND

This disclosure relates generally to data encoding models, and more particularly to increasing robustness of encoding models.

In many cases, encoder models receive data samples in an input space and are trained to output representations, termed embeddings, in a representation space. The encoder models learn to generate embeddings that better characterize relevant information about the data samples. The encoder model is often a general-purpose framework that may be trained on a large number of training data samples and may be self-supervised to learn relevant representations without reference to a particular application or task. Typically, different “adaptor” or “downstream” models may then use the embeddings produced by the encoders for specific tasks, such as classification, segmentation, prediction, depth prediction, and so forth.

However, in many cases, a change in the input data sample can have an outsized effect on the embedding generated by the encoder and subsequently on the prediction made by a downstream model. For example, an image of a cat (and correctly classified by a classification model as a cat) may be modified with noise or other small variations that results in an outsized effect on the embedding and result in an incorrect classification despite what appears to be a small modification (e.g., human evaluation would still clearly identify the cat). As such, in many cases, the embeddings generated by the encoder can be unexpectedly fragile or brittle with respect to small changes in the data samples that intuitively should not be expected to yield significant differences in the resulting embeddings. This may prevent such models from effectively accounting for this type of variation when it occurs in live data sets.

### SUMMARY

To improve encoder model robustness, a robust encoder model may be trained that reduces the change in embeddings for these “small” differences in data samples relative to an initial encoder. To do so, “adversarial” training data samples are generated for one or more training data samples. The adversarial training data samples are similar to the training data samples and thus “should” be represented similarly in the embedding space. Although the adversarial training data samples should also be similar in the embedding space, the initial encoder generates an adversarial embedding that more significantly differs from the training data sample.

To generate an adversarial training data sample for a particular training data sample, the training data sample is processed by the initial encoder to determine the corresponding training embedding. The embedding may represent a portion of the data sample (e.g., an image patch embedding) or may represent the data sample as a whole (e.g., an image CLS token embedding). Then, the training data sample may be perturbed to identify an adversarial data sample that diverges from the training data sample in the embedding space. The perturbation of the training data sample may be within a maximum perturbation (guaranteeing a sufficient similarity to the training data sample) while increasing (e.g., maximizing) the distance in the representation space. The perturbation of the data sample may be iteratively performed to explore the direction and type of perturbation that most affects (increases) the distance in the representation space. In some embodiments, each iteration may be a step of a projected gradient descent. In other embodiments, candidate adversarial data samples may be generated with differing perturbations and the selected adversarial data sample for that iteration is the candidate having the maximum difference in the embedding space.

After identifying adversarial data samples for corresponding training data samples, a robust encoder may be trained to reduce the difference in embedding pace between the training data samples and corresponding adversarial data samples. In addition, the robust encoder may also be trained to maintain the encoding of the training data sample (i.e., the embedding generated by the robust encoder had a minimized distance to the embedding generated by the initial encoder). In one embodiment, the robust encoder may be a fine-tuning of the initial encoder (e.g., initialized with parameters of the initial encoder).

### BRIEF DESCRIPTION OF THE DRAWINGS

FIG. 1 illustrates an example model training system for improving model robustness, according to one embodiment.

FIG. 2 shows a conceptual data flow illustrating adversarial effects in an embedding of modifying a data sample, according to one or more embodiments.

FIGS. 3A-B illustrate an input data space and corresponding embeddings with an adversarial data sample, according to one embodiment.

FIG. 4 is an example method for improving model robustness, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

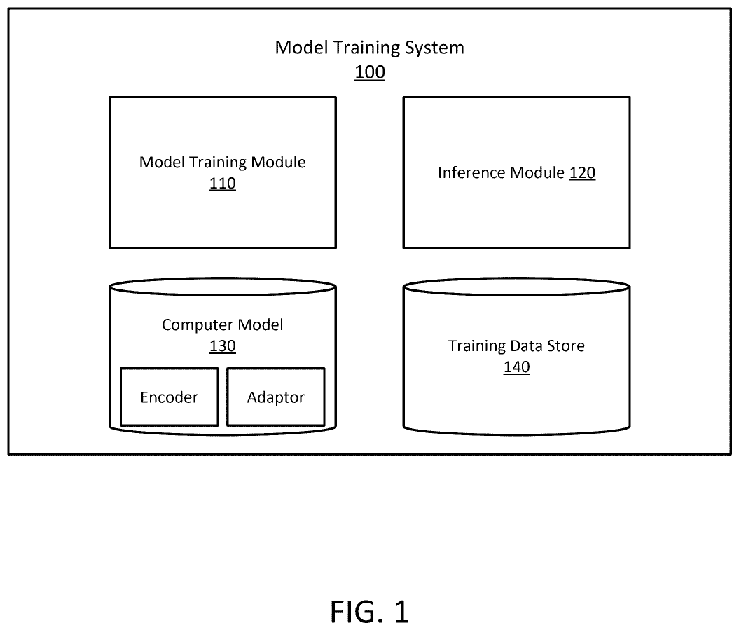

FIG. 1 illustrates an example model training system 100 for improving model robustness, according to one embodiment. The model training system includes an encoder that generates “embeddings” that represent data samples in an embedding space. The embeddings may then be used by an adaptor model for specific tasks. The model training system 100 includes a model training module 110 for improving robustness of a computer model 130 with respect to generated embeddings with a set of training data in a training data store 140. Particularly, the model training module 110 generates “adversarial” data samples based on training data samples in the training data store 140. The adversarial data samples are perturbed versions of the training data samples that have relatively high differences in the embedding space with the unperturbed data samples. The model training module 110 then trains a robust encoder model that reduces the distance in the embedding space between the training embedding and the adversarial embedding. This may reduce the effect of small differences in the data space from overly affecting the differences in the embedding space, enabling the model to more effectively account for small changes in the data sample.

The computer model 130 includes a set of trained parameters and may include various types of model architectures and networks that vary across different embodiments and data types. The model architecture may include varies types of processing layers and connections between them. The model architecture may thus include fully-connected layers, pooling layers, convolution layers, recurrent layers, rectification layers, attention layers, activation layers, skip connection between layers, upsampling, downsampling, and so forth. In general, computer models are trained to learn model parameters that optimize an objective function (or conversely minimize a loss function) with respect to one or more training goals.

In many configurations, the computer model 130 includes an encoder and one or more adaptors. The encoder processes an input data sample to generate an embedding that represents the data sample that may be effective for multiple different purposes. The adaptors receive the output embeddings and provide additional layers that are fine-tuned for particular tasks, such as classification, segmentation, depth estimation, and so forth.

Typically, the encoder is trained to generate embeddings that meaningfully represent relevant aspects of the input data sample and typically does so in a representation space having a dimensionality smaller (often significantly smaller) than the dimensionality of the data space. In many cases, the encoder may also be trained with self-supervised learning, such that the encoder may be trained separately (and often in advance) of any specific downstream application. The encoder may be an open source or other “foundational” model that may be trained on a very large data set to represent the data type effectively across a large number of potential use cases. In embodiments discussed herein, the computer model 130 is applied to image data samples and, in varying embodiments, the encoder model is a pre-trained DINO or DINOv2 encoder. In additional embodiments, different types and architectures of encoder model may be used for images or different data types, such as video, audio, text, tabular data, and various additional types of data. In addition, from the perspective of the model training system 100, in many cases the encoder may have parameters that are pre-trained by another system. In additional examples, a pre-trained encoder may be fine-tuned by the model training module 110 with respect to particular training data or downstream tasks relevant to the particular computer model 130.

In some examples, the encoder may be trained to learn a representation space relevant to reconstructing the data samples (e.g., as an autoencoder). In additional examples, the encoder may be trained based on two or more semantic-preserving augmentations of a data sample applied to the data samples, such that the outputs of the semantic-preserving functions are aligned in the representation space. For example, the semantic-preserving augmentations of data sample x may yield x₁ and x₂ and the encoder f may be trained with a loss function L that minimizes a distance d between the different augmentations of the same data sample: L (f, x)=d(f(x₁),f(x₂)). The encoder is thus typically designed to characterize data samples in a way that is expected to be useful for a variety of different downstream tasks and typically is trained to learn representations with self-supervised learning (e.g., unsupervised).

The representation space in different embodiments may characterize data samples as embeddings that describe different aspects of an input data sample (e.g., based on the data type or the expected use case). As one example, the generated embedding may be a global embedding that represents the data sample as a whole. For example, in certain image encoders, a “CLS token embedding” may be generated that characterizes the entire image. As additional examples, particularly for data types having an inherent structure, the encoder may generate “regional embeddings” that describe regions, areas, or hierarchies within the data sample. For example, image encoders may generate “patch embeddings” that characterize regions or patches of an input image data sample. In other contexts, regions or portions of a data sample may be similarly represented with separate embeddings. In addition, in various embodiments the encoder may generate multiple types of embeddings, such as a global embedding, in addition to multiple regional embeddings.

The computer model 130 also typically includes one or more adaptors (i.e., additional computer model components with trainable parameters) that can learn parameters for particular downstream processes. Typically, the adaptor models may be trained on a smaller data set than the encoder model and may be trained with labeled training data to learn parameters that predict the labels based on the embeddings generated by the encoder. In addition, the adaptor models are typically significantly smaller with fewer parameters than the encoder model, such that the adaptor models may benefit from the distribution of different data samples in the representation space generated by the encoder. The adaptor models in some cases may be linear models, fully-connected layers, or otherwise relatively lightweight relative to the encoder. As an example for images, adaptors may be used for classification (characterizing an image), segmentation (detecting object boundaries), or depth estimation (a distance of a pixel or pixel regions from the imaging sensor).

The model training module 110 may train parameters of the computer model 130, including the encoder and one or more adaptors, based on a set of training data in the training data store 140. The model training module 110 may apply various training approaches to modify parameters of the computer model 130, typically to improve an objective function (or reduce a loss function) evaluated with respect to the training data. As discussed further below, the model training module 110 may generate adversarial data samples and apply the adversarial data samples to improve robustness of the computer model 130 to modifications of the data sample.

The model training system 100 in some embodiments may also perform inference on data samples with an inference module 120 by applying learned parameters of the computer model 130. The inference module 120 may receive data samples from additional systems or from another database (not shown) and process the data sample through the encoder and related adaptor to obtain the model's prediction with respect to a particular data sample. The particular application of the inference module 120 varies in different embodiments and may include distributing the inference module 120 and, after training, computer model 130 to various computing systems to serve inference requests. As such, while inference module 120 is shown as a portion of the model training system 100, in deployed configurations, the inference module 120 may be separate from the model training module 110, such that a computer model 130 trained by one system is sent for application by systems implementing the inference module 120.

Although these components are shown in FIG. 1 as part of a model training system 100, in additional embodiments, these components may be located at various separate systems. For example, in one embodiment, the computer model 130 is trained by one computing system, while another computing system applies the computer model 130 to new data samples based on the trained parameters of the model. Similarly, individual components of the model training system 100 may also be distributed across multiple computing systems. For example, the model training module 110 may be distributed across multiple training systems, such that one set of systems is configured to jointly train the encoder of the computer model 130, while other systems are configured to train one or more adaptors.

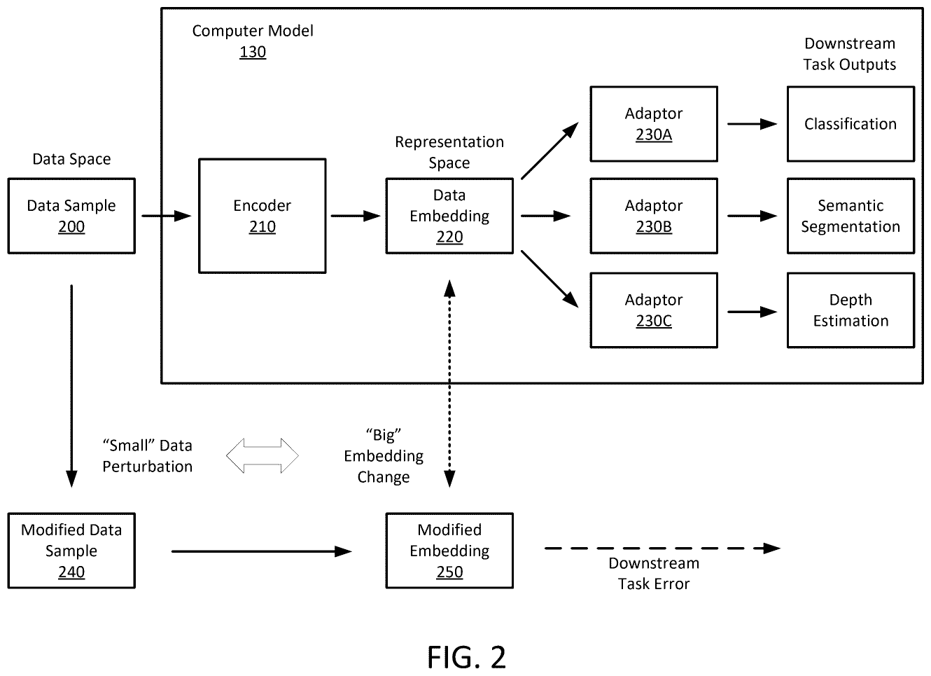

FIG. 2 shows a conceptual data flow illustrating adversarial effects in an embedding of modifying a data sample, according to one or more embodiments. As discussed above, in operation a data sample 200 is processed by a computer model 130 by applying parameters of an encoder 210 to generate a data embedding 220 that represents the data sample 200. The data embedding 220 may then be used by different adaptors 230A-C for different downstream tasks. In this example, adaptor 230A predicts a classification for the image, adaptor 230B predicts semantic segmentation, and adaptor 230C estimates depth.

Although the encoder 210 is expected to learn embeddings that encode relevant differences across images, in many cases, the data embedding 220 may be undesirably “brittle” with respect to changes in the data sample 200. That is, relatively small perturbations of the data sample 200, represented as a modified data sample 240, when evaluated by the encoder 210, may yield a modified embedding 250 having a relatively large change in the embedding. That is, although the data sample 200 and modified data sample 240 are relatively similar, the change between the data embedding 220 and a modified embedding 250 is more significant than would be expected. As a result, while the small modification to the data sample 200 may not be expected (or intended) to affect downstream tasks, the comparatively large change in representation of the data sample in the embedding space may induce errors in the downstream tasks evaluated by the adaptors 230A-C.

As one situation, this may occur when the computer model 130 is deployed for inference of new data samples that may present differences from the training data samples. For example, for image data the training data may be captured with a particular type of imaging sensor or under certain conditions. When deployed for inference, captured images may differ due to different image sensors, imaging settings, and imaging conditions. Captured images may present different color balance, sharpness, focus, blur, and other characteristics that may cause small changes to what would otherwise be expected or the “same” image if captured by the imaging methodology of the training data. When the modified embedding 250 for an image is significantly different than what may be expected given the extent of a change in the data perturbation for the modified data sample 240, the embedding representation may be less robust to these types of data sample modifications than desired. Because the same encoder and resulting embedding may be used across multiple adaptors, the “overly” modified embedding may induce worse performance across multiple downstream tasks.

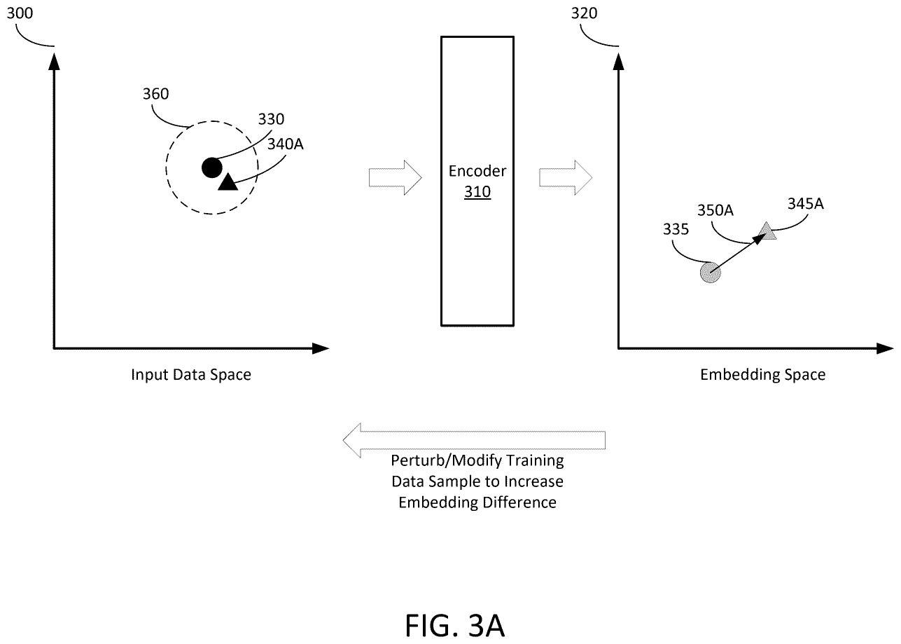

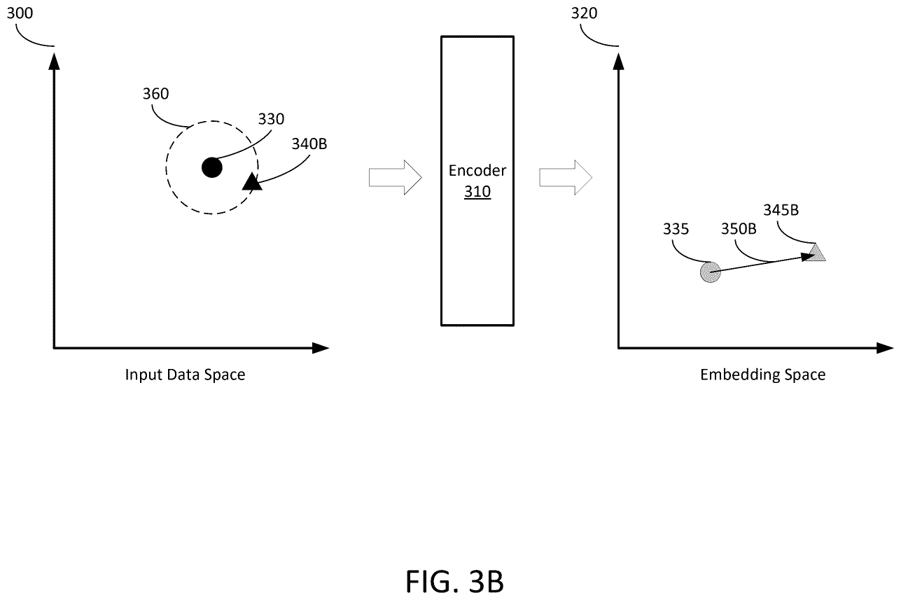

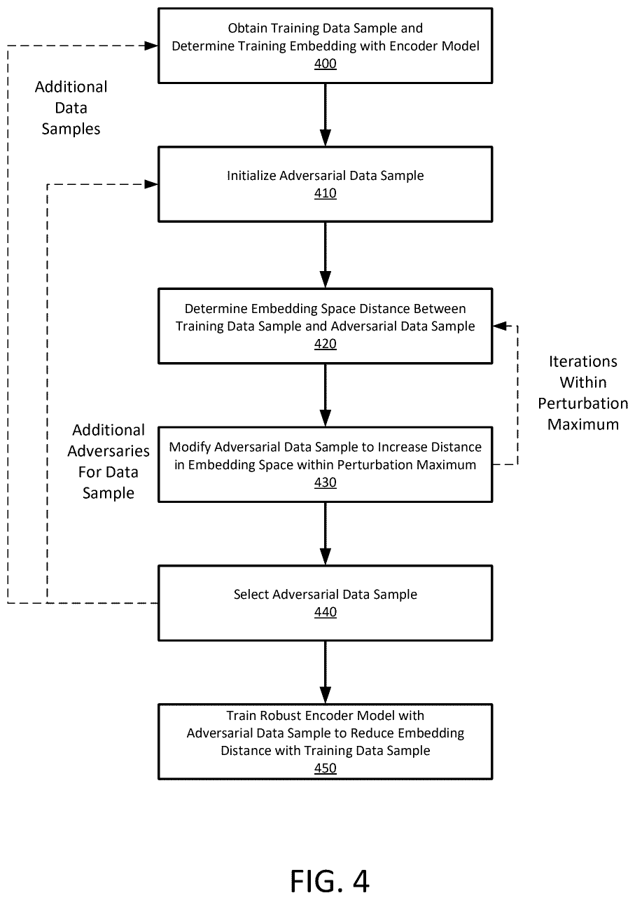

FIGS. 3A-B illustrate an input data space and corresponding embeddings with an adversarial data sample, according to one embodiment. To account for the potential effect discussed above, the model training module 110 generates “adversarial” data samples in the data space that provide contrastive examples for learning encoder parameters that more robustly account for “small” changes in data samples. Additional details for generating adversarial data samples are discussed below, particularly with respect to FIG. 4. Initially, a training data sample 330 in an input data space 300 may be processed by an encoder 310 to determine a corresponding training embedding 335 in an embedding space 320. The embedding space may differ in various embodiments, and may depend e.g., on the particular adaptors and downstream tasks for the computer model and the relevant embedding space used by the adaptors. As such, the relevant embedding space may be a global embedding space (e.g., a CLS token embedding) for adaptors that use global embeddings, such as an image classification task that applies to the image as a whole, while the embedding space for other tasks may be a regional embedding, such as a patch embedding, that characterizes regions of the input image. The particular embedding space used in different embodiments for adversarial data samples may depend on the downstream adaptor(s).

To generate the adversarial data sample, perturbations may be applied to the training data sample 330 to generate an adversarial data sample 340A within a maximum perturbation threshold 360. The maximum perturbation threshold 360 provides a maximum perturbation distance from the training data sample 330 and may define the limit of a “small” perturbation of the data sample in the input data space. The adversarial data sample 340A is processed by the encoder 310 to determine the corresponding position of an adversarial embedding 345A in the embedding space 320.

A distance 350A is determined in the embedding space between the training embedding 335 and the adversarial embedding 345A so that the adversarial data sample 340A may be further modified to increase the distance 350 in the embedding space. In the examples of FIG. 3A-B, the adversarial data sample 340 may be iteratively modified to increase the distance 350, such that FIG. 3B shows a subsequent iteration of FIG. 3A. As shown in FIG. 3B, additional perturbation of the training data sample 330 to an adversarial data sample 340B results in a new position for a corresponding adversarial embedding 345B having a higher distance 350B from the training embedding 335. As shown in the example of FIG. 3B, when the adversarial data sample 340B reaches the maximum perturbation threshold 360, the position of the adversarial data sample 340B and its corresponding adversarial embedding 345B may be used for improving robustness of the encoder 310.

FIG. 4 is an example method for improving model robustness, according to one embodiment. This method may be performed, for example, by the model training module 110 of FIG. 1. As an overview, a set of adversarial data samples are generated based on a set of training data samples and a robust encoder is trained to reduce the distance relative to the initial encoder between pairs of training embeddings and adversarial embeddings.

Initially, the method obtains 400 a training data sample for which to generate an adversarial data sample and uses the encoder model to determine the corresponding training embedding. In embodiments where the adversarial data sample is iteratively determined, the adversarial data sample may first be initialized (410) for the first iterative step. The initial adversarial data sample 410 may be the same as the training data sample, may be a randomized perturbation of the training data sample (e.g., randomized noise), or may be a randomized position within the perturbation maximum. In the data space, distance between the training data sample and the adversarial data sample (for comparison with the perturbation maximum) may be measured in various ways and in one embodiment is an 1_{∞}-norm.

Next, the adversarial data sample may be modified (e.g., for each iteration) to increase the distance in the embedding space between the adversarial data sample and the training data sample. To do so, the training embedding and adversarial embedding are determined by applying the encoder to the training data sample and the adversarial data sample to determine a distance in the embedding space between the training data sample and its associated adversarial data sample. The distance in the embedding space may be measured in various ways and in one embodiment is measured as an 1₂ norm: ∥f(x)−f(x_{adv})∥₂, where f() is the encoder, f(x) is the training embedding, and f(x_{adv}) is the adversarial embedding.

The current distance may then be used to modify the adversarial data sample 430 to increase the distance in the embedding space between the training data sample and the adversarial data sample. In one embodiment, the distance may be increased iteratively by taking gradient steps in the input space towards a direction that maximizes an increase in distance in the embedding space. The gradient steps may be clipped (i.e., truncated) to a portion (e.g., a third, fourth, eighth, etc.) of the value of the maximum perturbation, such that multiple gradient steps are required to reach the maximum perturbation, ensuring that multiple iterations evaluating step direction are taken until maximum perturbation of the adversarial data sample (relative to the training data sample). In one embodiment, the adversarial data sample is modified with a step based on projected gradient descent evaluated with respect to the data space.

The maximum perturbation varies in different embodiments and typically represents a relatively small change in the data sample. In one embodiment, the maximum perturbation is 1/32 of the range of a dimension of the data sample (e.g., a perturbation of 8/255 for a dimension having a range from 0 to 255). The maximum perturbation may have other values in different embodiments that may absolutely or relatively describe a difference in the input space that is expected to have comparatively small an amount of difference in the input space. The maximum perturbation may also be determined based on a training data sample distribution, such that the maximum perturbation is smaller than the distance (or half the distance) between any two training data samples, such that the maximum perturbation cannot convert one training data sample into another.

After modifying the adversarial data sample 430, additional iterations of determining 420 the embedding space distance and further modifying the adversarial data sample 430 may be performed until a stopping condition. The stopping condition may be the adversarial data sample reaching a perturbation maximum with respect to the data sample in the data space, or may be a maximum number of iterations, a local maximum distance, or another suitable condition. After modifications of the adversarial data sample, the adversarial data sample is selected for use with the training data sample, such that the adversarial data sample is a data sample in the input space that is close to the training data sample but provides a relatively high difference with the data sample in the embedding space. The training data sample and the selected 440 adversarial data sample may then be associated together as a pair for training 450 of a robust encoder model.

In some embodiments, additional adversarial data samples may be selected 440 for the same training data sample, such that multiple pairs of adversarial data samples and training data samples may be used with the same training data sample. To do so, another adversarial data sample is initialized 410 (e.g., with different noise or at a different location within the maximum perturbation from the data sample) and modified 430.

Within a given set of training data samples, the process may also be repeated for additional training data samples, such that a set of pairs of training data samples and adversarial data samples are determined and may be used to train 450 the robust encoder model. Since the adversarial data samples represent data samples that have corresponding distances in the embedding space that are most distant (within the maximum perturbation) from the training data samples, this potential misalignment of model parameters may be addressed by training a robust encoder model that reduces the embedding distance between training embedding and associated adversary embedding for each pair of training data samples and adversary data samples. The robust encoder model may have the same architecture as the initial encoding model. In some embodiments, the robust encoder model is initialized with parameters of the initial encoder and fine-tuned based on the adversarial data samples. When training 450 the robust encoder model, the robust encoder model is trained with an objective to learn embeddings that decrease the embedding distance between the pairs of training data samples and the adversarial data samples. In addition, the robust encoder model may also be trained with an objective to maintain training embeddings at the same position as the training embeddings generated by the initial encoder.

As one example loss function for training the robust encoding model, the loss function may aim to reduce a weighted combination of: 1) the distance in the embedding space between training data sample (training embedding) and adversarial data sample (adversarial embedding); and 2) the distance in the embedding space for the training data sample between the initial encoder and the robust decoder. Particularly, a loss function L(f_{R}, f) for training parameters of the robust encoding model f_{R} with respect to an initial encoding model f and a training data sample x with its adversarial data sample x_{adv} may be defined as:

$$L ( {f}_{R} , f ) = d ( {f}_{R} ( x ) , f ( x ) ) + γ d ( {f}_{R} ( {x}_{adv} ) , {f}_{R} ( x ) ) \qquad Equation 2$$

where d is a distance metric in the embedding space (e.g., a cosine similarity);
d(f_{R}(x), f(x)) is a factor describing the distance between the embedding representation of the training data sample according to the robust encoder and the initial encoder
d(f_{R}(x_{adv}), f_{R}(x)) is a factor describing the distance between the training embedding and adversarial embedding based on the robust model; and
γ is a hyperparameters defining the relative weighted contribution of the two factors.

By generating relevant adversarial data samples, the initial model can be fine-tuned to reduce the types of downstream effects on adaptor models that may occur when embeddings significantly change despite insignificant changes in an input data sample. The robust encoder may be used in the computer model to improve model performance with improved embedding representations. In further examples, in addition to the adversarial data samples with respect to the embedding space, adversarial data samples may also be generated with respect to downstream tasks, such that data samples may be generated that unexpectedly affect downstream task prediction. These additional downstream adversarial examples may be used in conjunction with the adversarial data samples based on the embedding space to further refine model parameters and prevent unexpected behavior due to small input data changes.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for improving artificial intelligence model robustness, comprising:
one or more processors; and
one or more computer-readable media, comprising instructions executable by the one or more processors for:
determining a training embedding in an embedding space by applying a training data sample in an input space to an initial encoder;
generating an adversarial data sample with a perturbation of the training data sample based on a distance between an adversarial embedding of the adversarial data sample in the embedding space to the training embedding; and
training a robust encoder model based on the initial encoder to decrease the distance between the training embedding and the adversarial embedding.

2. The system of claim 1, wherein generating the adversarial data sample comprises iteratively perturbating the adversarial data sample until a threshold perturbation.

3. The system of claim 1, wherein the adversarial data sample is perturbed with projected gradient descent to increase the distance between the adversarial embedding and the training embedding.

4. The system of claim 3, wherein steps of the projected gradient descent are clipped.

5. The system of claim 1, wherein the training also trains the robust encoder model to maintain the training embedding of the training data sample.

6. The system of claim 1, wherein parameters of the robust encoder model are initialized to parameters of the initial encoder before training the robust encoder model.

7. The system of claim 1, wherein the instructions are further executable for:
generating a robust data embedding with the robust encoder model applied to a data sample not included in a training data set for the initial encoder; and
generating a downstream model output by applying an adaptor model to the robust data embedding.

8. The system of claim 1, wherein the embedding space is a patch embedding or CLS token embedding.

9. A method for improving artificial intelligence model robustness, comprising:
determining a training embedding in an embedding space by applying a training data sample in an input space to an initial encoder;
generating an adversarial data sample with a perturbation of the training data sample based on a distance between an adversarial embedding of the adversarial data sample in the embedding space to the training embedding; and
training a robust encoder model based on the initial encoder to decrease the distance between the training embedding and the adversarial embedding.

10. The method of claim 9, wherein generating the adversarial data sample comprises iteratively perturbating the adversarial data sample until a threshold perturbation.

11. The method of claim 9, wherein the adversarial data sample is perturbed with projected gradient descent to increase the distance between the adversarial embedding and the training embedding.

12. The method of claim 11, wherein steps of the projected gradient descent are clipped.

13. The method of claim 9, wherein the training also trains the robust encoder model to maintain the training embedding of the training data sample.

14. The method of claim 9, wherein parameters of the robust encoder model are initialized to parameters of the initial encoder before training the robust encoder model.

15. The method of claim 9, wherein the method further comprises:
generating a robust data embedding with the robust encoder model applied to a data sample not included in a training data set for the initial encoder; and
generating a downstream model output by applying an adaptor model to the robust data embedding.

16. The method of claim 9, wherein the embedding space is a patch embedding or CLS token embedding.

17. A non-transitory computer-readable medium for improving artificial intelligence model robustness, the non-transitory computer-readable medium comprising instructions that, when executed by a processor, cause the processor to:
determine a training embedding in an embedding space by applying a training data sample in an input space to an initial encoder;
generate an adversarial data sample with a perturbation of the training data sample based on a distance between an adversarial embedding of the adversarial data sample in the embedding space to the training embedding; and
train a robust encoder model based on the initial encoder to decrease the distance between the training embedding and the adversarial embedding.

18. The non-transitory computer-readable medium of claim 17, wherein generating the adversarial data sample comprises iteratively perturbating the adversarial data sample until a threshold perturbation.

19. The non-transitory computer-readable medium of claim 17, wherein the adversarial data sample is perturbed with projected gradient descent to increase the distance between the adversarial embedding and the training embedding.

20. The non-transitory computer-readable medium of claim 19, wherein steps of the projected gradient descent are clipped.
